(19) United States
(12) Patent Application Publication
(10) Pub. No.: US 2009/0152955 A1
(43) Pub. Date: Jun. 18, 2009

(54) ADVANCED SWITCHER FOR HIGH OUT ELECTRONIC DEIVES

(76) Inventors: Eddy Chan, Dale City, CA (US); Michael Hui, San Francisco, CA (US)

Correspondence Address: PENINSULA IP GROUP, 26150 BUCKS RUN, CORRAL DE TIERRA, CA, 93908, US

(21) Appl. No.: 11/955,654

(22) Filed: Dec. 13, 2007

(51) Int. Cl. H02B 1/24

(52) U.S. Cl. 307/112

(57) ABSTRACT

Disclosed herein is a circuit and device for activating and deactivating various high current output electrical devices, where such electrical devices are particularly appropriate for use in a hydroponic growing system. The circuit includes, a timer, a controller, a switch pair, defining a channel, one ballast connected to the switch pair and two high current output devices connected to one ballast. In an exemplary embodiment, the high current output device defines a high intensity light of the type commonly used in the indoor growing industry. The circuit includes the controller being connected to each the ballasts and upon the appropriate signal from the timer, the controller sends a high signal to switch which, in turn, sends a high signal to the ballast, which, in turn, powers one and only one of the high current output devices. In an exemplary embodiment there are six ballasts, each with two lighting arrays.

### BACKGROUND OF THE INVENTION

### Field of the Invention

This invention relates to a circuit and device for switching on and off high output electronic devices, particularly those used in the hydroponic growing industry. And, more particularly this invention relates to electrical circuits used for activating and deactivating high output electronic devices such as lighting arrays which are designed for use in the indoor growing industry.

In today's world of advanced indoor hydroponics, various arrays of electronic equipment provide optimal growing conditions for hydroponic crops. Typically, the one thing that each of the electronic devices have in common is that they are high intensity devices which require large amounts of electrical power to function properly. For example, in present indoor growing environments a single ballast is required for each lighting array. Thus, many successful companies are forced to buy duplicates electronics in order to meet the growth demands of their crops and the power constraints of working with traditional power companies.

Growers must successfully negotiate all requirements of lighting, feeding, and humidity in order to achieve a successful crop. As is well understood, different plant varieties require different environmental conditions for optimal growth and thus an optimal crop yield. Successful growers select and customize electronic systems that cater to the their particular varieties of different plants and even different species of the same plant.

Thus, for example, In the same hydroponic environment, a variety of different crops may be harvested. Each crop will need an environment that is particularized to itself and very likely there will be multiple and even duplicate electronic arrays needed to specifically cater to each plant variety.

Different electronic systems are as varied as the species for which they are designed. For example, some systems include aeroponic spray systems, dripper systems, nutrient film systems and others barely more than soil in a pot. Although modern electronic systems vary from user to user, the essential elements, such as high intensity discharge lighting, cooling fans, pest filtration systems (carbon scrubbers), plant nutrient, plant containers, growing medium, and nutrient induction system, can be found in nearly all such garden environment.

In one such environment, the electronic arrays are adapted to provide the correct number of hours of light to simulate plants that bloom in different seasons of the year. Cooling equipment coordinates with the lighting to achieve the optimal temperature. Quite often multiple grow areas are required to combat the heat generated by the high intensity discharge lighting. Additionally, power requirements must be considered in order to properly distribute power so as not to overload circuits or cause equipment failure. Thus, it is critical for the switch which controls the electronic arrays to provide the required varied environmental conditions for different crops for optimal growth, while at the same time making sure that the electronic systems function continuously in the way designed.

In the past multiple timers and even switches were needed to perform and synchronize the above electronic array functions. For example, in the past, it was required to use a single ballast to turn on each lighting array. Hydroponic growers have been particularly cautious not to overload circuits by having too many devices on one switch. If too many devices are on one switch overloads can result in catastrophic failure include a condition known as “ALL ON” wherein all the electronic arrays turn on at once causing massive crop loss and eventually electronic failure and disastrous loss of equipment. Additionally, such conditions may even cause a safety hazard in the form of a electronic overload fire.

From the very complex to the extraordinarily simple environmental system for hydroponic growing, what is needed is a switch to effectively and efficiently manage the electronic arrays. Additionally, the switch must be able to effectively cycle the electronic arrays within each environmental system without causing power failures and while providing each electronic array with sufficient power to do its job. The switch desired would also allow growers to cut duplicate electronic arrays without sacrificing optimal growing conditions for their plants.

### SUMMARY OF THE INVENTION

In order to meet the demand of the hydroponic growing industry, the instant invention provides an apparatus for controlling electronics in an indoor gardening system, the apparatus defines an electrical circuit, comprising a timer connected to the electrical circuit, a controller connected to the electrical circuit, at least one switch pair connected to the electrical circuit, one ballast connected to each of the switch pairs, two high current output devices connected to each switch pair and the controller connected to the switch and based upon the appropriate signal from the timer, the controller sends a high signal to switch which, in turn, sends a high signal to the ballast, which, in turn, alternates the power between one switch and then the other in the switch pair, such that one and only one of the high current output devices is powered at one time.

It is an object of this invention to provide an electrical apparatus which allows two lighting arrays for hydroponic growing to be powered using a single ballast.

It is an additional object of this invention to provide such an electrical apparatus which ensures that each electronic array connected to the electronic apparatus in accordance with this invention receives sufficient voltage from the power supply.

It is an additional object of this invention to provide such an electrical apparatus which defines a switch and wherein the switch includes a random generator connected to the means for supplying power to the lighting array wherein the lighting array turns on/off at the same time each within 60 seconds before or after and wherein the plus or minus 60 second interval is randomly selected.

In accordance with the above objects and those that will be mentioned and will become apparent below, the circuit for the switch in accordance with this invention comprises:
a timer connected to the electrical circuit;
a controller connected to the electrical circuit;
at least one switch pair connected to the electrical circuit, the switch pair defining a channel;
at least one ballast connected to the circuit and powering a single switch pair;
the controller connected to at least one switch pair and based upon the appropriate signal from the timer, the controller sends a high signal to switch to power the ballast, which, in turn, switches power one of the switches in the switch pair to the other of the switches in the switch pair.

In an exemplary embodiment of the electrical circuit of the invention, the circuit includes a random number generator which allows the circuit to supply power to each of the lighting arrays connected to the circuit at the same time each day, plus or minus 60 seconds, the time interval being randomly selected.

In an exemplary embodiment of the electrical circuit of the invention, the circuit includes circuitry which staggers the activation of the ballasts, so that one and only one ballast turns on at time.

It is an advantage of this invention to a provide an electrical circuit which allows more than one lighting array to be connected to each ballast.

It is an advantage of this invention to a provide an electrical circuit which turns on and off the connected lighting arrays at the same time each day, within a plus or minus 30 time interval each and wherein that time interval is randomly selected.

### BRIEF DESCRIPTION OF THE DRAWING

For a further understanding of the objects and advantages of the present invention, reference should be had to the following detailed description, taken in conjunction with the accompanying drawing, in which like parts are given like reference numerals and wherein:

FIG. 1 is an illustration of the electrical apparatus in accordance with the invention herein.

FIG. 2 is a schematic representation of the overall circuit for the electrical apparatus in accordance with the invention herein.

FIG. 3 is a detailed circuit schematic illustrating the functioning of the randomization function of the electrical apparatus in accordance with the invention herein.

FIG. 4 is a detailed circuit schematic illustrating the input signal processing in accordance with this invention.

FIG. 5 is detailed circuit schematic illustrating the step down voltage regulator of the electrical apparatus in accordance with the invention herein.

FIG. 6 is detailed circuit schematic illustrating the step up voltage regulator of the electrical apparatus in accordance with the invention herein.

FIG. 7 is a circuit schematic of the relay circuit in accordance with this invention in use.

FIG. 8 is a schematic illustration of the electrical apparatus in accordance with the invention herein shown in use.

### DETAILED DESCRIPTION OF THE INVENTION

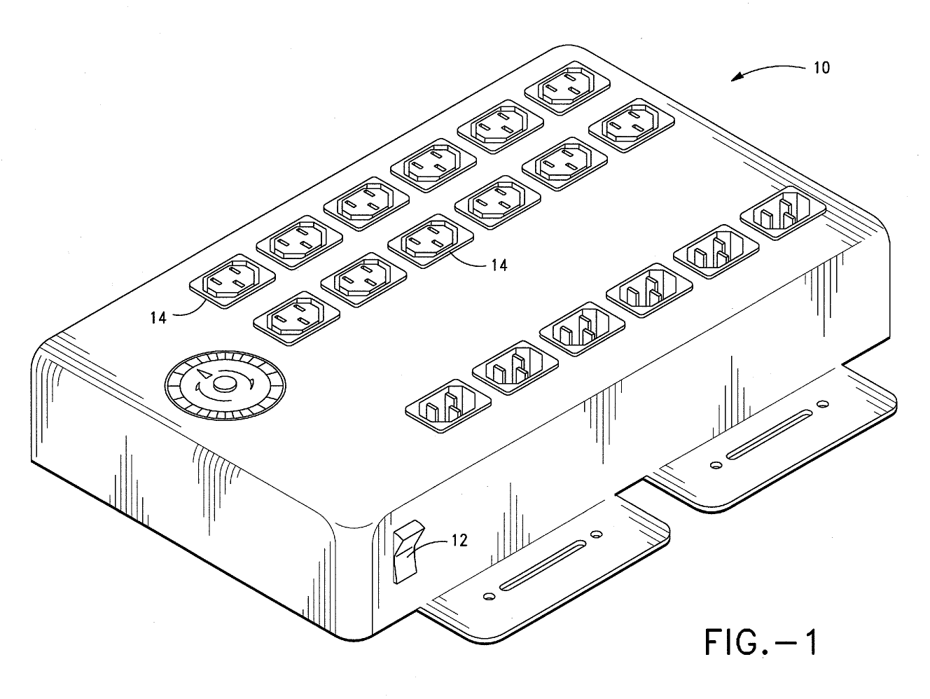

The invention will now be described with respect to FIG. 1, which illustrates a preferred embodiment of the invention, an electrical apparatus defining a switch for hydroponic electronic arrays, shown generally by the numeral 10. The switch 10 includes a plug for connection to a wall outlet (not shown). The switch 10 acts like a regular household appliance and is powered by 110 V ac. A cord (not shown) plugs into the switch 10 at receptacle 12. The hydroponic electronics plug into receptacles 14. Each receptacle 14 operates in conjunction with a relay as will be explained below.

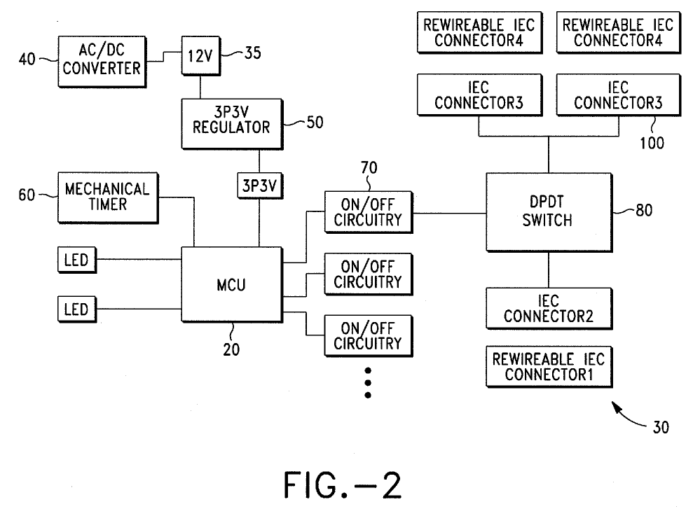

With particular reference to FIG. 2, there is shown the general schematic of the electrical circuit in accordance with this invention a high current PCB (printed circuit board) shown generally by numeral 30.

Shown in FIG. 2 is a microcontroller in the form of an MCU 20 (Micro controller unit). The circuit includes a 12 v power supply 35, an AC/DC converter 40, a 3 volt regulator (3P3V) 50, a mechanical timer 60, on/off circuitry 70, a relay 80, a switch pair including a first switch 90 and a second switch 100.

Power from the utility is supplied to the circuit at 110 V AC to both the converter 40 and the timer 60. The 12 V dc power supply 35 is powered through the AC/DC converter 40 after the signal is converted from 110 V ac to 12 V dc. The 12 V dc signal is sent to a step down voltage regulator 50. A more detailed explanation of the step down voltage regulator circuit is set forth in FIG. 5. The 3 V dc power is supplied to the MCU 20 and thereby powers the MCU 20. The MCU sends a 3 V dc signal to the timer 60.

Upon an activation signal from the timer 60, the On/Off circuitry 70 sends a signal to the Relay 80. The relay switches power from one of the switch pair to the other. In other words, the if the switch 100 is powered, upon appropriate signal from the on/off circuitry 70, power switches from switch 100 to switch 90.

In an exemplary embodiment there are a plurality of switch pairs. Thus, in one particularly embodiment there are six pairs of switches and of course, a like number of ballasts and the appropriate circuitry and internal circuit devices to run the circuit in the manner discussed above. Similarly, other embodiments may have 10 or 20 switch pairs and the other necessary elements to have the circuit work in the manner described above.

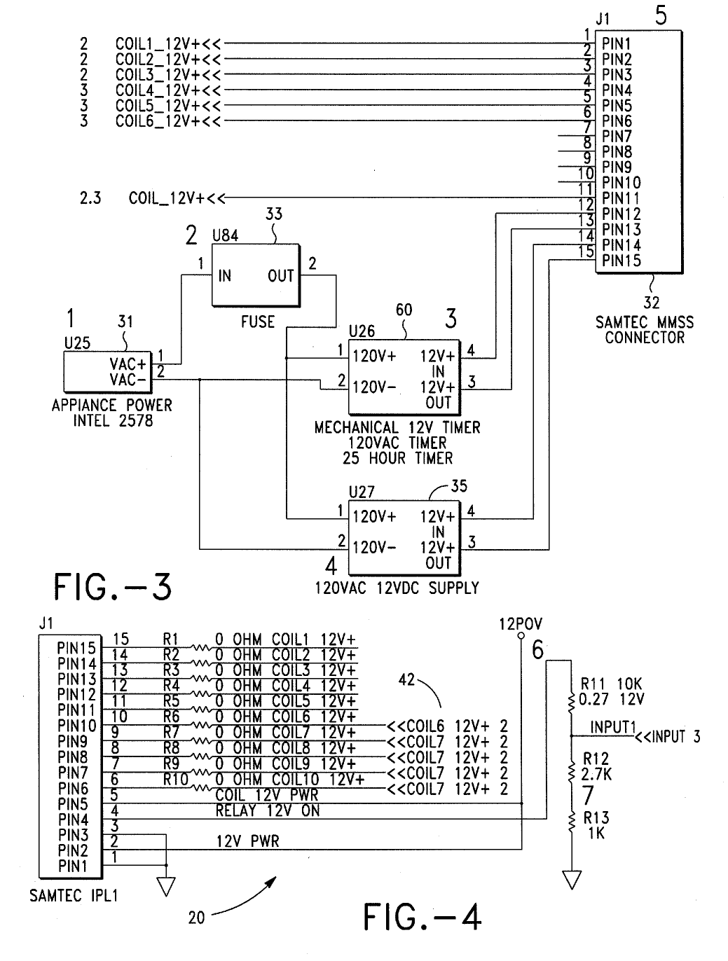

In exemplary embodiments having more than a single switch pair, the activation of the individual switch must be staggered to prevent circuit overload and to ensure that each electronic device attached to the circuit, such as lighting and the like, receives the necessary power to safely turn on and run properly. This requires a staggering of the activation of the switch pairs. In fact, in one aspect of this invention the switch pairs are activated in a staggered manner every twelve hours, plus or minus 60 seconds. And the plus or minus 60 seconds is determined on a random basis as will be more fully appreciated with respect to the detailed description of FIGS. 3 & 8 below.

In the exemplary embodiment shown in FIG. 2, the relay 80 comprises a DPDT switch and the switch pair includes IEC Connector 3 designated as numeral 100 and IEC Connector 2 designated as numeral 90. Sending the signals through the on/off circuitry 70 causes the DPDT relay 80 to become activated. If, for example, the DPDT relay 80 is wired to for lighting, a lighting signal is sent to IEC CONNECTOR2 (input) 90 and flips the signal from the one IEC CONNECTOR3 (resting output) 100 to the other IEC CONNECTOR3 (switched output).

The IEC CONNECTORS shown in this drawing are all contained on a high current printed circuit board 30. The high current printed circuit board 30 houses the DPDT relay 80, and both IEC CONNECTORS outputs. The input is attached to the high current printed circuit board via a 5″ lead wire and quick connect terminals. The high current printed circuit board 30 houses the relays and two out of three IEC connectors directly on the board, while the last remaining IEC connector is connected via wire and solder.

In the embodiment shown in FIG. 2, the AC/DC converter 40 is a 25 watt ac/dc power converter (dc power supply) and is converted to 2 a of 12 vdc. This is the power required to power the relays contained in this embodiment.

Illustrated in FIG. 3 is an exemplary embodiment of the circuit diagram which creates the randomization of the activation of the switch pairs. For purposes of greater understanding, it is helpful to think of each switch pair as a single channel having two switches 90 and 100. The individual activation signal for each channel sent from the micro controller unit 20 is never sent to more than one switch pair at a time. Rather each activation is sent separately in a random order generated by the MCU 20. The MCU 20 includes a random generator. As noted above the lighting array connected to an exemplary embodiment of the circuit turns pm at the same time each day within plus or minus 30 seconds. Thus, there is a 60 second interval in which the lighting array connected to the circuit turns on. This interval is randomly determined by the random generator within the MCU 20.

The circuit includes a power supply from the wall (110 vac) through the 2 pin appliance inlet 31. The power signal is sent through the panel mount fuse holder 33 and then onto the 12 vdc power supply 35 and to the onboard SPST mechanical timer 60. Although, 110 V ac is sent to the timer 60, it does not switch on the timer. It merely powers the timer 60 so that it can be activated. As noted with respect to FIG. 1, 110 vac is sent from wall outlet (not shown) through 2 pin appliance inlet 31.

The Samtec MMSS connector 32 is a removable connector that mates with the pc board mounted header of the pc board controller. The connector 32 accepts the 12 V dc power signal. Pins 12-13 send a 3 V dc to the mechanical timer 60. The 3 V dc signal activates and deactivates the timer setting on the timer.

The SPST mechanical timer 60 includes a 24 hour user programmable relay in accordance with the instant invention. The relay is programmed to respond to the circuit. The SPDT timer 60 can be either switched on or off according to the jumper setting set by the user. When the timer 60 is selected on, the timer receives the 12 vdc signal, when timer is selected off, the 12 V dc power is disconnected and no signal is received. The 12 vdc power sent by the timer 60 is used an signal only, and is not used to power any peripheral in the system.

In general, It has been found that variations in lighting are an actual aid to growers and produce more vibrant and larger crops. Thus, a randomization program as set forth above allows a grower to obtain higher and better yields for his crops. The grower using this circuit in conjunction with his plants thus achieves an important improvements.

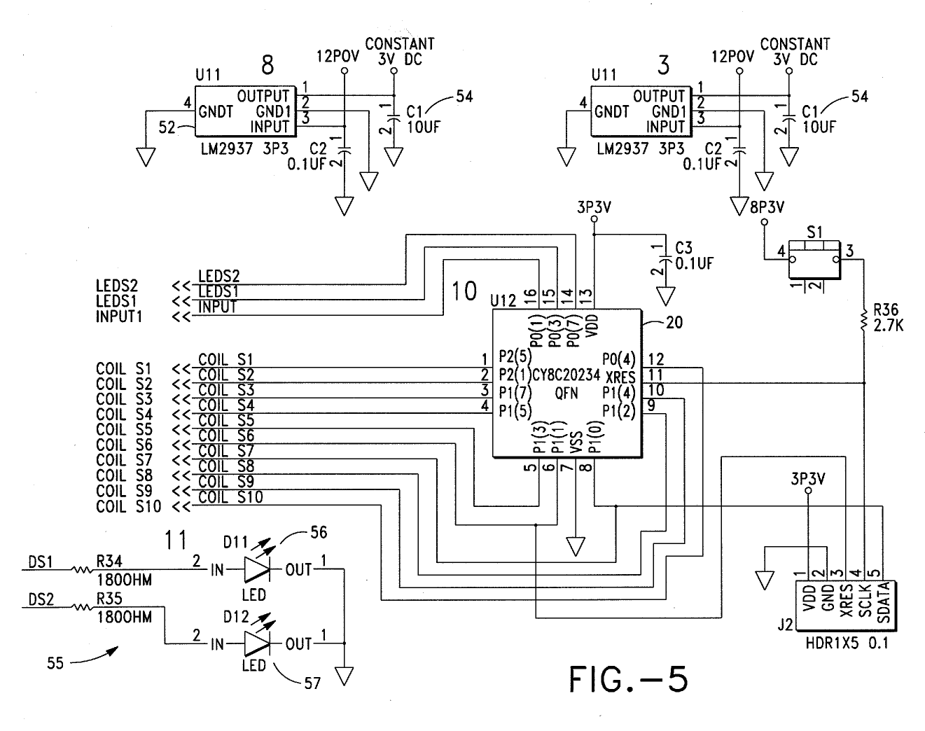

With respect to FIG. 4, there is shown how the current of the system is maintained at proper tolerance levels throughout the circuit of the invention. It will be appreciated that each internal circuit device is designed to use a current at a certain level and within its predefined tolerance range. The circuit illustrated in FIG. 4 is an exemplary embodiment of this function of the circuit in accordance with this invention. The 12 V dc signal is converted to 3 vdc using a series of resistors 41, including a 10 k, 2.7 k, and a 1 k resistor as shown. As will be appreciated, the MCU 20 of the exemplary embodiment of FIG. 1 accepts only a 3 V dc power signal. Once converted 3 vdc power signal is used to power the MCU 20. The MCU 20 then performs its functions, including appropriately powering the relays, randomization and the like. After processing by the resistors, the coils 42 then manage the current level to maintain it at the proper level within the tolerance framework of the individual device on board.

With respect to FIG. 4, there is shown a detailed view MCU 20. The MCU 20 includes a plurality of coils 42 which function as follows:
Coil signal to relay circuit 1 (Pin 11)
Coil signal to relay circuit 2 (Pin 12)
Coil signal to relay circuit 3 (Pin 13)
Coil signal to relay circuit 4 (Pin 14)
Coil signal to relay circuit 5 (Pin 15)
Coil signal to relay circuit 6 (Pin 16)
Coil signal to relay circuit 7 (Pin 17)
Coil signal to relay circuit 8 (Pin 18)
Coil signal to relay circuit 9 (Pin 19)
Coil signal to relay circuit 10 (Pin 20)

With respect to FIG. 5, there is shown a Step Down Voltage Regulator 52 in one exemplary embodiment of the circuit of the invention. The circuit includes a 10 uF capacitor 54. A constant 12 vdc signal is provided as an input signal by the power supply (FIG. 2) to the Step Down Voltage Regulator 52. The 12 V dc is converted to a 3 V dc signal by sending the signal to Step Down Voltage Regulator 52 and then through the 10 uF capacitor 54. The 3 vdc signal is used to supply a constant voltage to power the MCU 20. As will be appreciated, the constant 3 vdc supplied to the MCU 20 keeps the MCU 20 powered at all times.

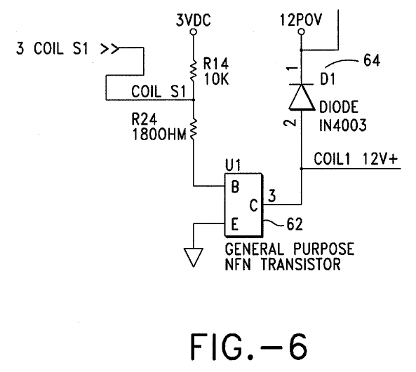

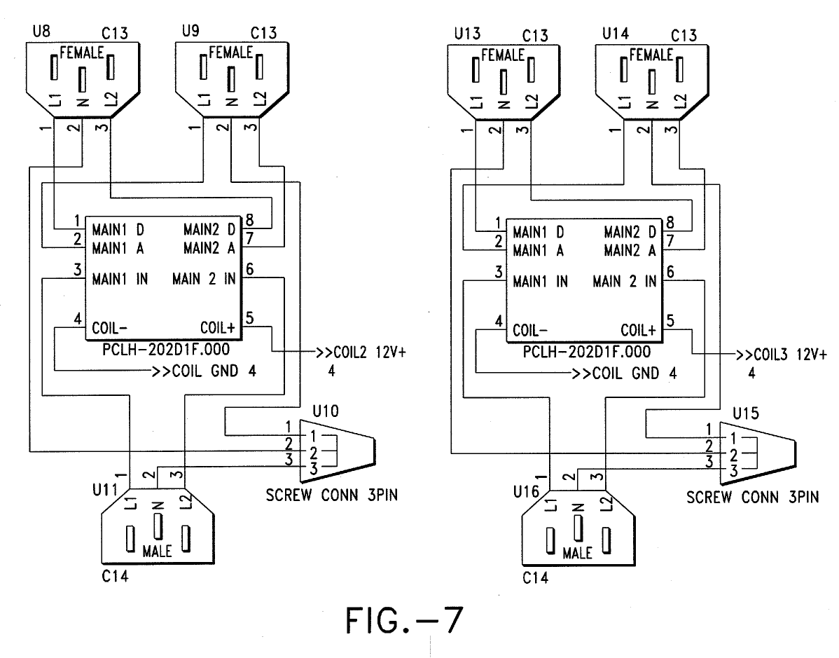

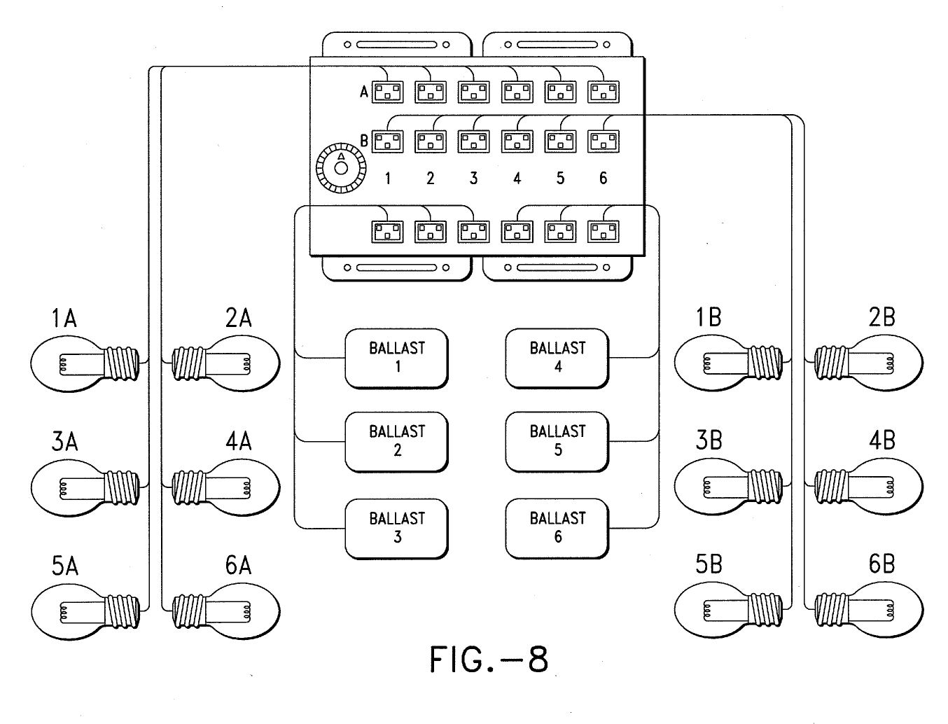

When signaled, the MCU 20 is activated and sends an output signal to trigger the relays 80 (FIG. 7). Since the output signal is 3 V dc, the signal must go through processing before it is sent to trigger the relays. To do so, the signal must be converted to 12 V dc. The General Purpose NPN Transistor 62, FIG. 6, receives a 3 vdc is sent from the MCU 20 and the NPN transistor 62 converts the output signal to a 12 vdc signal. The output signal is sent to the ground on the controller pc board.

A diode 64 dissolves any residual power left in the lines as the relays 80 power on and off. The diode 64 is also used to isolate the power signal to prevent back flow that could damage the MCU 20. The circuit shown in FIG. 6 is repeated 10 times, one for every coil 42 in FIG. 4.

The circuit includes an LED connected to the timer 60. The LED's indicate when the is on or for example when or which set of lighting is currently activated. The activation of particular set of is controlled by the MSU which activates only one set at a time in accordance with the invention. The signal to the LEDs is adjusted to provide the proper signal for long term durability of the LED. The circuit 55 illustrated in FIG. 5 is an embodiment of such a protective circuit. The circuit 55 includes a 180 ohm resistor (56 & 57) applied inline with the LED

With respect to FIG. 6, there is shown the step up Voltage Regulator which powers the 3 V dc to 12 V dc. As will be appreciated, the only device on the circuit that uses the 3 V dc is the MCU 20. All signals emanating from the MCU must therefore be powered up in order to perform their function. Particularly, in order to signal the relays 80, the voltage must be stepped up from 3 V dc to 12 V dc. The circuit of FIG. 4 includes a general purpose NPN transistor 62 and diode 64. As the 3 V dc is sent through the transistor 62 it is stepped up to a 12 V dc signal. The 12 V dc signal is sent through the diode 64 which resolves the power in the manner described above with respect to FIG. 5 and ensures a 12 V dc signal is sent to the relays 80 within the tolerance limits of the relays 80.

With respect to FIG. 7, there is shown an exemplary embodiment of the functioning of the relays 80 in accordance with this invention. As noted above, the circuit is designed to handle a plurality of relays and channels. There are an equal number of channels and relays 80. Illustrated in FIG. 7 is a two channel system, including two relays 80 and two channels of switch pairs, having switches 90 and 100.

A signal is received from the on/off circuitry 70 (FIG. 1) after appropriate activation by the MCU 20. One switch of the channel is always on and upon receiving a signal a the other switch of the channel is turned on after turning off the first switch. In other words, assuming switch 90 is on and supplying power to a connected electronic device (not shown), upon receipt of a signal from the relay 80, the switch 90 deactivated and the switch 100 is activated, turning on the electronic device connected thereto.

In the circuit of FIG. 7, there a first channel 110 and a second channel 120. In order to ensure proper and safe activation of the electronic devices connected thereto, the signal activating the relay is staggered by the MCU 20. As noted above, one switch of the channel is always on in the exemplary embodiment of the invention described herein. Within a 12 hour period, plus or minus 60 seconds, randomly determined, the other switch will be activated by activating the next relay 80.

FIG. 8 illustrates the electrical apparatus 10 of the invention in use. In the exemplary embodiment shown, there are six ballasts and six channels. Each of the six channels is connected to an electronic device, in this case, lighting 130. For purposes of explanation, it will be assumed that all the electronic devices connected to the channels are lighting. It will, of course, be appreciated that various electronic devices could be similarly connected and the invention is not confined to lighting devices.

Each ballast powers a pair of lighting devices 130. As the signal to change from the A device to the B device is received, power is turned off from a single A device and a single B device is powered. Each B device is powered in staggered, and random order. Typically, one device of each channel will always be receiving power and the other device of the same channel will be deactivated. Also, typically, each channel will alternate activation in a 12 hour period, plus or minus 60 seconds. The 60 seconds being randomly determined by the MCU 20.

While the foregoing detailed description has described several embodiments of the device and circuit in accordance with this invention, it is to be understood that the above description is illustrative only and not limiting of the disclosed invention. Particularly, there can be a variety of different circuit elements and even different circuit embodiments within the spirit and scope of this invention. It will be appreciated that the embodiments discussed above and the virtually infinite embodiments that are not mentioned could easily be within the scope and spirit of this invention. Thus, the invention is to be limited only by the claims as set forth below.

What is claimed is:

1. An apparatus for controlling electronics in an indoor gardening system, the apparatus defining an electrical circuit, comprising:
a timer connected to the electrical circuit;
a controller connected to the electrical circuit;
at least one switch pair connected to the electrical circuit, the switch pair defining a channel;
at least one ballast connected to the circuit and powering a single switch pair;
the controller connected to at least one switch pair and based upon the appropriate signal from the timer, the controller sends a high signal to switch to power the ballast, which, in turn, switches power one of the switches in the switch pair to the other of the switches in the switch pair.

2. The circuit of claim 1, wherein there is a high current electronic device in each of the switches of the switch pair, whereby one ballast powers two high current electronic devices.

3. The circuit of claim 1, wherein there are a plurality of ballasts, each powering a single switch pair, whereby each ballast powers two high output electronic devices.

4. The circuit of claim 1, wherein a the controller staggering the high signal to the switch such that one and only one ballast receives a high signal at any point in time to power one and only one of the high current output devices.

5. The circuit of claim 1, wherein circuit includes converter means which appropriately converts 110 ac to 12 v dc.

6. The circuit of claim 3, wherein the circuit includes converter which converts 12 v dc to 3 v dc and back again as appropriate.

7. The circuit of claim 1, wherein the controller includes a random number generator, which sends a signal to the timer instructing the timer to randomly send a high signal within predetermined limits.

8. The circuit of claim 7, wherein the predetermined limits are plus and minus 60 seconds.

9. The circuit of claim 8, wherein the timer is on a predetermined cycle.

10. The circuit of claim 9, wherein the predetermined cycle is 12, whereby each ballast is activated randomly within 12 hours, plus or minus 30 seconds.

11. The circuit of claim 1, wherein there an equal number of ballasts and channels.

12. The circuit of claim 11, wherein there are six ballasts and six channels.

13. The circuit of claim 11, wherein there are ten ballasts and ten channels.

14. The circuit of claim 11, wherein there are twenty ballasts and twenty channels.

15. The circuit of claim 7, wherein there are an equal number of ballasts and channels and wherein there are at least two channels and wherein the activation of each channel is staggered so that only one channel is activated at a time.

16. The circuit of claim 15, wherein there a plurality of channels, each channel being activated once a period, where the period is 12 hours plus or minus 60 seconds and wherein the sixty second is randomly determined by the random generator.

17. The circuit of claim 16, wherein there are six ballasts and six channels.

18. The circuit of claim 16, wherein there are ten ballasts and ten channels.

19. The circuit of claim 16, wherein there are 20 ballasts and 20 channels.
